(19) United States
(12) Patent Application Publication
(10) Pub. No.: US 2010/0104811 A1
(43) Pub. Date: Apr. 29, 2010

(54) Tamperproof information ticket

(76) Inventor: René Jallot, Le Perreux sur Marne (FR)

Correspondence Address: JORDAN AND HAMBURG LLP, 122 EAST 42ND STREET, SUITE 4000, NEW YORK, NY, 10168, US

(21) Appl. No.: 12/308,790

(22) PCT Filed: Jun. 25, 2007
(86) PCT No.: PCT/FR2007/001054

§ 371 Date: Oct. 15, 2009

(30) Foreign Application Priority Data
Jun. 26, 2006 (FR) 0605714

(51) Int. Cl. B44F 1/10; B32B 9/00; B32B 3/10; B32B 27/32; B32B 3/00; B32B 3/28

(52) U.S. Cl. 428/153; 428/411.1; 428/195.1; 428/523; 428/181

(57) ABSTRACT

A tamperproof information ticket includes at least one transparent top sheet or layer, having a surface that is adapted to receive confidential printing, such as a confidential code and at least one bottom sheet or layer comprising means for scrambling the confidential printing, the scrambling means being visible through the top sheet or layer. The scrambling means can be irreversibly disabled by way of deformation of at least one part of said bottom sheet or layer.

The present invention relates to a tamperproof information ticket for bearing information in a secure manner.

Information tickets are currently used to provide users with secret codes, such as credit card codes. A code of this sort must only be known by its user, and must not be readable by the person who transcribes the information onto the ticket (for example, a printer transcribing a confidential code onto a ticket) nor may this be readable by any other person who is not the end-user of the code.

Tamperproof information tickets are already known, such as those described in U.S. Pat. No. 5,466,012. This document describes a security system comprising a base sheet, on which confidential information is presented, and a cover sheet with printing serving to make the confidential information illegible. The printing comprises lines separated by spaces without printing. The system does not allow confidential information to be printed without the person who performs the printing being able to see it, because the information is printed at the interior of the system.

U.S. Pat. No. 5,029,901 describes a base sheet bearing confidential information and an opaque cover sheet, which prevents the information from being read from the exterior. The two sheets can be separated in order to read the printing at the interior. In this case as well, the confidential printing is inside the sheet, and is invisible after the cover sheet been put in place. The printer, therefore, has access to the confidential information.

FR-2662530-A describes a tamperproof information support or ticket comprising at least a transparent top sheet or layer having a surface adapted to receive confidential printing and at least one bottom sheet or layer comprising means for scrambling said confidential printing, the scrambling means being visible through said top sheet or layer, wherein said scrambling means can be irreversibly disabled. In this document, claim 6 recites that the scrambling pattern is seen through an initially transparent layer, which is made opaque so as to cancel the scrambling effect. In this document, according to claim 8, which is dependent from claim 6, the scrambling pattern is disposed on a support, which allows for disabling by way of a mechanical or physical action. When the scrambling pattern is seen through a transparent layer, the transparent layer is acted upon in order to disable the scrambling means.

U.S. Pat. No. 5,238,272 describes a ticket comprising a bar code, for which protection is desired. Thus, the ticket comprises two sheets, between which there is a strip bearing the barcode, this strip being folded under the top sheet, so as to protect the barcode. A ticket of this sort bears confidential information, which is printed beneath a non-transparent sheet. In order to manufacture a ticket of this sort, it is necessary to print the barcode before the various sheets that constitute the ticket are assembled. Because the barcode is not confidential information, many identical copies of the barcode can be printed, which serve to identify a product. In this document, because the object is to protect the barcode from being read by consumers, or from being damaged, the printed bar code may be read by the printer when the tickets are manufactured.

In the field of confidential printing, such as printing personal codes, there is a demand for a solution whereby these cannot be read by anyone other than the person for whom they are intended, at any time. Thus, there is a demand for being able to camouflage these confidential codes as soon as they are printed, which is to say that, when the confidential codes are transcribed onto the ticket, they are immediately illegible, and the system remains tamperproof until it arrives at the intended recipient.

Use is also made of codes that are masked by scrambling means, which are printed on a support, and then printed with a number, and then covered with an opaque coating, which can be scratched off. This type of system is used, in particular, for lottery tickets. However, these systems have a disadvantage in that the code is printed directly on the lottery ticket and it can be seen from the back as a result of transparency, in addition to which, the printer sees the printed code, while lottery tickets must always be distributed in a random manner, from one day to the next, and no one must know the numbers thereof in advance.

WO 99/24267 describes a tamperproof information ticket comprising: a transparent top sheet, the top surface of which is adapted to receive printed information, and a nontransparent bottom sheet, having scrambling means, which are visible through the transparent top sheet. The transparent top sheet and the nontransparent bottom sheet are joined together. The information printed on the top surface of the transparent top sheet becomes visible when the join between the transparent top sheet and the nontransparent bottom sheet is broken. The physical separation provides proof that the security of the information has been breached. The bottom sheet can be a substrate, or the nontransparent bottom sheet is a covering or a mask, that can be scratched off or peeled off from the bottom of the transparent top sheet. The transparent top sheet can be scored or split, so as to prevent removal of the confidential printing information.

In this prior document, in order to read the confidential printed information, it is necessary to remove the bottom sheet by peeling it off or scratching it off, so as to remove the scrambling means and make the confidential information visible. This document also mentions that the scrambling means can be negated or disabled by the application of heat, pressure or light. However, this disabling of the scrambling means requires the use of external means such as an iron, which requires an additional operation by the end-user, which may be a waste of time. In addition, in this case, the inks that form the scrambling means must be irreversibly thermosensitive or sensitive to light and/or pressure. Inks of this sort are not commonly available on the market, and because these are special inks, they are expensive. Here, many copies of the ticket must be produced and, therefore, the cost must not be excessive. In addition, the confidential information, such as a code, is printed by way of laser printing on the transparent sheet which, in practice, is made of a thermoplastic plastic material. When this is heated so as to disable the scrambling means, the thermoplastic transparent top sheet is deformed and the confidential code can no longer be read by the end-user. Such a tamperproof information ticket is, therefore, expensive and/or ineffective.

A ticket system is also known, which comprises:

a) a transparent sheet provided with a covering, which comprises microcapsules in a binder, at the center of the bottom face thereof; and

b) a zone bearing the printed confidential code, covered by a black scrambling layer, made from a colorant that reacts with the microcapsules on the transparent sheet.

When the transparent sheet is peeled off and then reapplied to the zone bearing the confidential code, and then the black zone bearing the confidential code is rubbed strongly, the black ink that hides the confidential code is discolored as a result of the reaction with the microcapsules. However, a system of this sort requires both that a transparent sheet provided with microcapsules be manufactured, and that the confidential code be printed in a predetermined zone bearing the scrambling means. This is, therefore, expensive to manufacture, and the cost is further increased by the cost of the microcapsules.

An object of the present invention is, therefore, to overcome the disadvantages of tamperproof information tickets in the prior art.

A first object of the present invention is to provide an information ticket that is tamperproof and convenient to use for the final recipient.

Another object of the present invention is to provide a tamperproof information ticket that is relatively inexpensive.

To this end, the present invention comprises a tamperproof information ticket comprising at least one transparent top sheet or layer, the top surface of which is adapted to receive printing, and at least one bottom sheet or layer comprising means for scrambling said printing, the scrambling means being visible through said top sheet or layer, characterized in that said scrambling means can be irreversibly disabled by way of deformation of at least part of said bottom sheet or layer.

The irreversible deformation of the bottom sheet or layer can be produced by drawing in the direction of an axis of the constituent material of said at least one part of the bottom sheet or layer, and preferably in the direction of the longitudinal axis thereof.

According to a mode of embodiment of the invention, the scrambling means comprise patterns in the same color as the printed information (for example, a confidential code), the bottom sheet or layer being of a predetermined color that is different from the color of the printed information, and by way of drawing the constituent material of the bottom sheet or layer, the scrambling means are changed so as to reveal the color of the bottom sheet or layer, so that the color of the printed information contrasts with the color of the bottom sheet or layer, whereby the printed information becomes visible.

Thus, according to the invention, the color of the scrambling means is irreversibly changed by mechanically drawing the bottom sheet or layer.

According to another mode of embodiment, the system described above comprises a transparent sheet or layer comprising a bottom sheet or layer in the form a longitudinal strip made of deformable material and fixed at one end to said transparent sheet or layer. By grasping the end of the strip of deformable material and pulling the opposite end thereof, the color is changed, whereby the printed confidential code appears on the top face of the top sheet or layer. According to this mode of embodiment, the strip is drawn in only one direction.

According to a third mode of embodiment, the tamperproof information ticket according to the present invention comprises a strip, provided, at the center of the bottom face thereof, with an adhesive that serves to fix the ticket on a support, the scrambling means being disabled by pulling the strip in two opposite directions.

According to yet another mode of embodiment, the tamperproof information ticket described above further comprises a support on which the deformable bottom sheet or layer is fixed, which in turn supports the transparent top sheet or layer. Thus, the deformable sheet or layer is a middle sheet or layer, between the transparent top sheet and the support.

The material that constitutes the deformable sheet or layer is a material characterized by plasticity. Because this is a material than does not have a memory, once this has been deformed as the result of pulling, the deformable sheet or layer does not return to its original form, so that it is impossible to reconstitute the scrambling means, which are permanently disabled.

Any material that elongates without memory can be used as the material characterized by plasticity.

For example, cast polyethylene or polypropylene films, papers of the crepe-paper type, accordion-folded papers or films, or pleated papers or films can be used.

In another example, the support can be a sheet or layer of A4 printing/writing paper, on which the information ticket is affixed, which comprises the deformable bottom sheet or layer and the transparent top sheet or layer. In this case, the support can be a sheet or layer of personalized letterhead paper, on which the tamperproof ticket of the present invention is affixed.

A ticket of this sort is used in the following manner: multiple copies of the ticket according to the present invention are prepared on a silicone tape, a ticket is affixed to a piece of personalized writing/printing paper, such as a sheet or layer that includes instructions allowing the end user to reveal the confidential information that is intended for them, as well as the letterhead and logo of the banking establishment and any other information deemed necessary by this banking establishment. Thereafter, the confidential code is printed on the transparent top sheet or layer of the ticket by a printer. The printer cannot read the confidential code because it is scrambled by the scrambling means, which are printed in advance on the strip-shaped bottom sheet or layer. Thereafter the complete item is delivered to the end user, who is the intended recipient of the confidential code. This person must then deform the strip-shaped bottom sheet or layer so as to permanently disable the scrambling means. They can then read the confidential code. If the person who disables the scrambling means is not the end user for whom the confidential code is intended, in no case will they be able to enable the scrambling means, because the strip-shaped bottom sheet or layer that bears the scrambling cannot be returned to its original form. The information ticket of the present invention is well protected.

The manner in which the invention can be carried out will be better understood by way of the following description, in conjunction with the accompanying drawings.

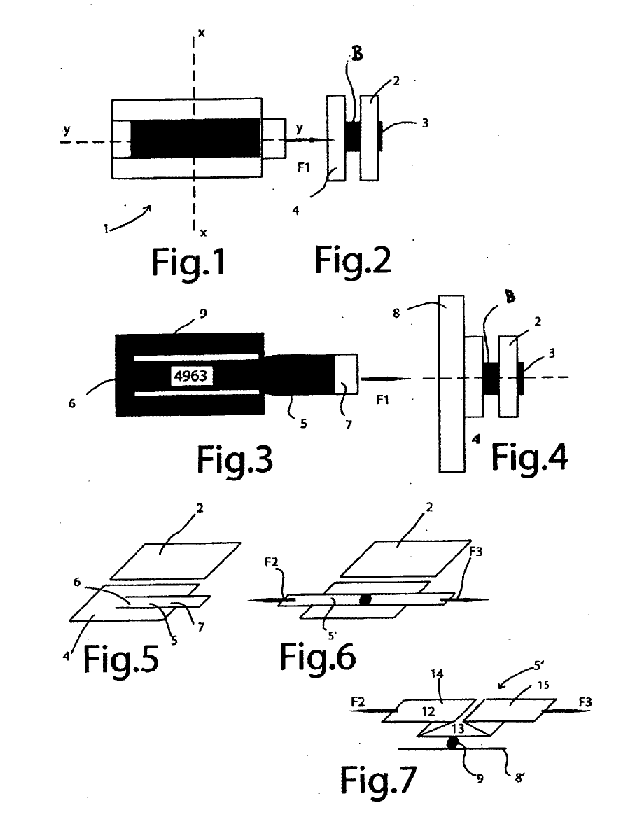

FIG. 1 shows a top view of a first mode of embodiment of the tamperproof ticket according to the present invention.

FIG. 2 is a sectional view along the axis YY of the tamperproof information ticket in FIG. 1.

FIG. 3 is a top view of the information ticket in FIG. 1, in which the deformable sheet or layer has been deformed.

FIG. 4 is a sectional view of a mode of embodiment of the information ticket of the invention, which is provided with a support.

FIG. 5 is an exploded perspective view of the first mode of embodiment shown in FIG. 1.

FIG. 6 is a perspective view of a second mode of embodiment of the present invention.

FIG. 7 is a view of the strip in the mode of embodiment in FIG. 6, in which this strip has been affixed to a support.

A first preferred mode of embodiment of the invention is shown in FIGS. 1, 2, 3, 4 and 5.

The ticket 1 shown in the drawings is a tamperproof information ticket. This ticket 1 is intended to be born on the letterhead paper of a banking group, credit institute or the like, which provides their clients with a confidential code, which is usually a code for a credit card, a debit card, a discount card or the like. The ticket according to the invention can also be used in order to provide a lottery number as part of a game of chance. The code number provided to the final recipient must not be fraudulently read by any third-party, such as the printer, the banker, or the organizer of the game, contest or the like. A piece of letterhead paper or a lottery ticket of this sort is referred to as a “support” in the present description. This support serves to receive the tamperproof ticket according to the present invention.

The ticket 1 comprises a transparent top sheet or layer 2, on the top face of which printing will be performed, usually by way of laser printing. This printing 3 imprints the confidential code that is intended for the end-user, such as a credit card holder or a lottery ticket purchaser. The ticket further comprises a bottom sheet or layer 4, which comprises scrambling means B, constituted by specific characters printed in black ink, which prevent the characters in the printing 3 from being read. The scrambling 4 is visible by way of the transparency of the sheet or layer 2. The scrambling means B must be positioned facing the part of the top sheet or layer 2, on which the secret code will be laser printed. According to the present invention, the scrambling means B are disabled by way of irreversible deformation of the bottom sheet or layer 4. The irreversible deformation can be produced by drawing the bottom sheet or layer 4. This may be drawn in any direction by the end-user. Thus, this can be drawn at an angle that is inclined with respect to the center axis XX of the ticket 1. However, according to a preferred mode of embodiment of the present invention, this is drawn in the longitudinal direction of the ticket 1, which is to say along the longitudinal axis YY of the ticket 1. As shown, the ticket is rectangular with a longitudinal axis YY, which is parallel to the long sides of the rectangle. In this mode of embodiment, this is drawn in only one direction, as indicated by the arrow F1. As can particularly be seen in FIG. 5, the irreversibly deformable bottom sheet or layer 4 is a rectangle comprising a strip 5 aligned with the longitudinal axis thereof, one end 6 of which being united with the bottom sheet or layer 4 while the opposite end 7 extends beyond the edge of the bottom sheet or layer 4. The strip is preferably cut into the bottom sheet 4, and made from the same material. Thus, the bottom sheet or layer 4 and the strip 5 can be made of a material characterized by plasticity, which is irreversibly deformable, such as a material characterized by plasticity without memory. However, it is conceivable that the bottom sheet or layer 4 cannot be drawn and that only the strip 5 can be drawn. For example, the bottom sheet or layer 4 can be made out of paper and the strip 5 can be made out of a deformable material, the end 6 of the strip 5 being fixed to the bottom sheet or layer 4. The bottom sheet or layer 4 can be made out of paper that cannot be drawn and the strip 5 can be made out of an irreversibly drawable material, such as a material characterized by plasticity without memory. What is important, according to the invention, is that the part of the bottom sheet or layer 4 that bears the scrambling means is deformable, and is configured so as to face the laser printing 3 of the secret code, so that, due to the transparency of the top sheet or layer 2, the printed secret code 3 and the scrambling printing 5 are superimposed. In the present description, the expression “bottom sheet or layer that can be deformed by drawing” refers to a bottom sheet or layer wherein, a portion thereof, or the entirety thereof, can be deformed by drawing. Thus, according to a mode of embodiment, the bottom sheet or layer may be constituted by a cut sheet or layer, into which a strip is cut, the bottom sheet or layer and the strip being made from the same deformable material, which does not have a memory. It is also possible, according to the invention, that the sheet or layer 4 is a non-deformable sheet or layer that supports a deformable part 5, in the form of a strip, which in turn supports the scrambling means. The free end of the strip extends beyond the bottom sheet or layer 4, so as to constitute a gripping means. Thus, the end-user can pull the free end 7 of the strip 5 in the direction of the arrow F1, so as to deform part of, or all of, the bottom sheet or layer 4, so that, in either case, the part that supports the scrambling means is deformed.

According to another mode of embodiment, the scrambling comprises color means, for example a black color, which are of the same color as the color of the laser printed secret code. The color scrambling means serve to prevent reading of the secret code, due to the transparency of the top sheet or layer 2. The colored scrambling patterns must be printed on the deformable part of the bottom sheet or layer 4. The printed scrambling patterns are of a color that is different from that of the deformable part (or strip) of the bottom sheet or layer 4. If, for example, the scrambling printing and the secret code are black, the color of the deformable part of the sheet or layer can, for example, be white. When the end-user deforms the deformable part, which bears the scrambling means, the patterns that constitute the scrambling printing are separated from each other, allowing the color of the sheet or layer, or the color of the deformable part of the sheet or layer, to be seen. The difference in the color of the sheet or layer, or the deformable part of the sheet or layer, from that of the printed secret code results in a color contrast, which allows the secret code to be read. In this case, the scrambling means are said to be “diluted”. Any colors may be used for printing the scrambling means and the secret code, so long as these are different from the color of the deformable part of the bottom sheet or layer. Most commonly, the printing is performed with black ink, and the sheet or layer, or the deformable part of the sheet or layer, is white. But other combinations of colors are possible.

FIGS. 3 and 4 show the ticket 1 according to the invention affixed to a support 8. This support 8 is, for example, a piece of letterhead paper of a banking institution or a lottery ticket, and is usually printed in an ordinary fashion, so as to provide non-confidential information to the end-user. The top sheet or layer 2 and the bottom sheet or layer 4, as well as the end 6 of the strip 5 are united by way of an adhesive, for example, at the periphery 9 of the bottom sheet or layer and the top sheet or layer, leaving the strip 5 free, other than at the end 6 thereof, which is united with the bottom sheet or layer 4. Thus, the strip 5 should be free, so that this can be drawn in the direction of the arrow F1 by the end-user. FIG. 3 shows the strip 5 that has been drawn into its final state, which allows the secret code (4963) to be read.

FIGS. 6 and 7 show another mode of embodiment of the present invention. The strip 5′ can be stretched in two opposite directions (arrows F2 and F3). For example, the strip 5′ can be a longitudinal ribbon fixed, at the center thereof, to a support 8′, by way of an adhesive 9. The adhesive must be disposed on the face of the strip opposite from the transparent sheet or layer 2, so that the scrambling means, which are printed on the face 12 of the strip, facing the transparent sheet or layer 2, are enabled when the strip 5′ is folded. The strip 5′ can be unfolded when the user pulls on the free ends 10, 11 of the strip 5′, in opposite directions, in accordance with the arrows F2 and F3. When the strip 5′ is unfolded, the scrambling means printed on the face 12, which faces the transparent sheet or layer 2, are separated as a result of the separation of the two facing parts 14, of the strip, and the scrambling means are disabled as a result of the appearance of the face 13, on which the scrambling means are not printed. If the scrambling means are constituted by black printing and the unprinted face 13 of the strip is white, the unprinted face 13 of the strip 5′ appears as a result of the strip 5′ being drawn from the two opposite ends thereof, and because this is white, the confidential code printed on the outer face of the transparent top sheet or layer 2 appears.

FIG. 7 shows a strip 5′, having one fold, but this strip may have a multiplicity of folds. For example, the strip may be crepe-paper. By printing one face of the crepe-paper with scrambling means and disposing the strip beneath the transparent sheet or layer 2, so that the scrambling means are positioned facing the area of the transparent sheet or layer 2 that will bear the printed confidential code, the design is such that, by pulling on the two free ends of the strip, the multiple folds of the crepe-paper, reveal the color of the unprinted crepe-paper when they are distanced from each other, so as to “dilute” the scrambling means, and reveal the confidential code.

The strip in the first mode of embodiment can also be made from crepe-paper.

In general, the bottom part on which the scrambling is printed can be any type of material that can be drawn in at least one direction, so long as the deformation thereof is irreversible. The deformable part can be made of a drawable plastic, which does not return to its original shape when the drawing force is released. Materials of this sort, which are characterized by plasticity, include, for example, cast polyethylene or polypropylene films, crepe-type papers, and accordion folded or pleaded papers or films.

1. A tamperproof information ticket comprising at least one transparent top sheet or layer having a surface adapted to receive confidential printing, and at least one bottom sheet or layer comprising means for scrambling said confidential printing, the scrambling means being visible through said top sheet or layer, that scrambling means being irreversibly disablable by way of deformation of at least one deformable part of said bottom sheet or layer, by drawing said at least one part of the bottom sheet or layer.

2. The tamperproof information ticket according to claim 1, wherein the scrambling means comprise patterns in the same color as the printed information, the bottom sheet or layer having a predetermined color that is different from the color of the printed information, and by way of drawing the constituent material of at least one part of the bottom sheet or layer, the scrambling means are changed so as to reveal the color of the bottom sheet or layer, so that the color of the printed information contrasts with the color of the bottom sheet or layer, and therefore the printed information becomes visible.

3. The tamperproof information ticket according to claim 1 or 2, wherein the bottom sheet or layer comprises a longitudinal strip portion made of deformable material and united, at least one end thereof, with the rest of the bottom sheet or layer, so that the longitudinal strip can be drawn only in one direction.

4. The tamperproof information ticket according to claim 1 or 2, further comprising a support on which a center part of said at least one deformable part of the bottom sheet or layer is fixed, which in turn supports the transparent top sheet or layer, so that the deformable part is drawable in two opposite directions.

5. The tamperproof information ticket according to claim 1 or 2, wherein the deformable part is constituted of a material characterized by plasticity and elongation without memory.

6. The tamperproof information ticket according to claim 1 or 2, wherein the at least one deformable part of said bottom sheet or layer is constituted of cast polyethylene or polypropylene film, crepe-paper, accordion-folded paper or film or pleated paper or film and is, then, deformable.

7. The tamperproof information ticket according to claim 1 or 2, wherein the confidential printing comprises a bank code or another confidential code that is intended to be used with a smart card.

8. The tamperproof information ticket according to claim 1 or 2, wherein the confidential printing comprises a lottery number.
